(19) United States
(12) Patent Application Publication
(10) Pub. No.: US 2025/0024316 A1
(43) Pub. Date: Jan. 16, 2025

(54) METHODS AND DEVICES FOR TRANSMITTING QUALITY OF SERVICE INFORMATION VIA USER PLANE

(71) Applicant: ZTE CORPORATION, Shenzhen (CN)

(72) Inventors: Yan XUE, Shenzhen (CN); Feng Xie, Shenzhen (CN); Bo Dai, Shenzhen (CN); Jinguo Zhu, Shenzhen (CN)

(73) Assignee: ZTE CORPORATION, Shenzhen (CN)

(21) Appl. No.: 18/898,802

(22) Filed: Sep. 27, 2024

Related U.S. Application Data
(63) Continuation of application No. PCT/CN2022/101235, filed on Jun. 24, 2022.

(51) Int. Cl. H04W 28/02; H04L 1/1867

(52) U.S. Cl. CPC H04W 28/0268; H04L 1/1867; H04W 28/0252

(57) ABSTRACT

The present disclosure describes methods, system, and devices for transmitting quality of service (QoS) information via a user plane. One method includes transmitting, by a first network element, first QoS information to a second network element by: transmitting, by the first network element, a data packet via user plane to the second network element, wherein the data packet comprises the first QoS information. Another method includes receiving, from a first network element by a second network element, first QoS information by: receiving, by the second network element, a data packet via user plane from the first network element, wherein the data packet comprises the first QoS information.

### TECHNICAL FIELD

The present disclosure is directed generally to wireless communications. Particularly, the present disclosure relates to methods and devices for transmitting quality of service (QoS) information via user plane.

### BACKGROUND

A data transmission session in a communication network may include one or more data flows. A data flow within such a data transmission session may be associated with Quality of Service (QoS) information. The QoS information involve characteristics or requirements of data flow and provide the guarantee of communication service capability. Delivery of the QoS information may involve various network nodes, elements, or entities in the communication network and a multitude of signaling processes between these network nodes, elements, or entities. Traditional QoS mechanism may be delayed in time with poor accuracy and reliability.

### SUMMARY

This document relates to methods, systems, and devices for wireless communication, and more specifically, for transmitting quality of service (QoS) information via user plane. The various embodiments in the present disclosure may be beneficial to improve the ability of QoS information transmission.

In one embodiment, the present disclosure describes a method for wireless communication. The method includes transmitting, by a first network element, first quality of service (QoS) information to a second network element by: transmitting, by the first network element, a data packet via user plane to the second network element, wherein the data packet comprises the first QoS information.

In one embodiment, the present disclosure describes a method for wireless communication. The method includes receiving, from a first network element by a second network element, first quality of service (QoS) information by: receiving, by the second network element, a data packet via user plane from the first network element, wherein the data packet comprises the first QoS information.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows a schematic diagram of various embodiments in the present disclosure.

FIG. 1C shows another schematic diagram of various embodiments in the present disclosure.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5 shows a schematic diagram of a non-limiting embodiment for wireless communication.

FIG. 6 shows a schematic diagram of a non-limiting embodiment for wireless communication.

FIG. 7 shows a schematic diagram of a non-limiting embodiment for wireless communication.

FIG. 8 shows a schematic diagram of a non-limiting embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for transmitting quality of service (QoS) information via user plane (UP).

In a communication network, an end-to-end communication may be established as a data communication session (alternatively referred to as a data session, or a communication session). Each data session may include transmission of data of different types, characteristics, and transmission requirements. As such, a data session may be configured as containing multiple data flows (which may be called QoS flow), with each data flow including data having similar transmission characteristics and/or associated with similar transmission quality requirements. Transmission of each of these data flows may be controlled and configured base on its transmission characteristics/requirements. For examples, allocation of communication resource to the data flow by the communication network may be based on the transmission characteristics/requirements of the data flow. Such transmission characteristics/requirements for the data flow may be used to determine a set of transmission parameters collectively referred to as QoS information for the data flow. The configuration of the transmission of the data flow (such as communication resource allocation) may then be based on such a QoS information. The determination and transmission of a QoS information may be performed by a network element in the communication network that is assigned for configuring and managing the transmission of the data flow. A “network element” may include one or more network nodes, one or more network functions, and/or one or more network entities.

A data flow may be associated with QoS information. In the network, QoS information is usually used to provide service guarantee capability. The QoS information involve characteristics or requirements of data flow. QoS information may include the information of QoS parameter and QoS policy, such as QoS profile, QoS rule, and/or policy control and charging (PCC) rule.

In traditional QoS mechanism, the QoS information is delivered via the control plane (CP). The delivery of the QoS information may involve various network nodes, elements, or entities in the communication network and a multitude of signaling processes between these network nodes, elements, or entities. In 5G new radio (NR), a core network (CN) maps the traffic of user plane to QoS flows, and the access network (AN) binds the QoS flows to data radio bearers (DRB). In order to complete the above mapping process, multiple control plane processes about QoS information transmission are required, involving multiple control plane network functions (NF) such as policy control function (PCF), session management function (SMF), access and mobility management function (AMF). The transmission mechanism of QoS information via control plane may be semi-static, a long chain, and/or the means of a single. Traditional approaches for QoS information transmission may be delayed in time with poor accuracy and reliability in QoS capability.

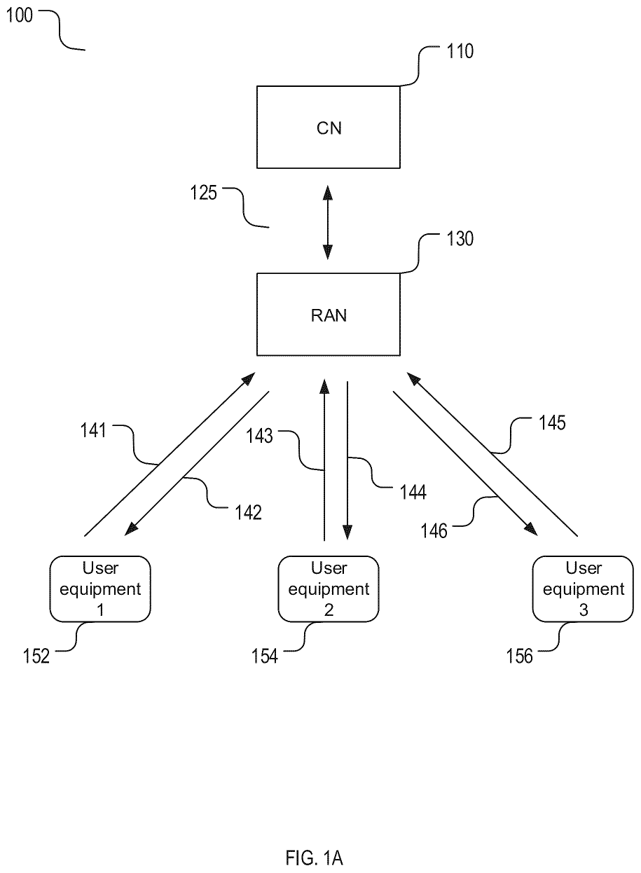

FIG. 1A shows a wireless communication system 100 including a core network (CN) 110, a radio access network (RAN) 130, and one or more user equipment (UE) (152, 154, and 156). The RAN 130 may include a wireless network base station, or a NG radio access network (NG-RAN) base station or node, which may include a nodeB (NB, e.g., a gNB) in a mobile telecommunication. In one implementation, the core network 110 may include a 5G core network (5GC), and the interface 125 may include a new generation (NG) interface.

Referring to FIG. 1A, a first UE 152 may wirelessly receive one or more downlink communication 142 from the RAN 130 and wirelessly send one or more uplink communication 141 to the RAN 130. Likewise, a second UE 154 may wirelessly receive downlink communication 144 from the RAN 130 and wirelessly send uplink communication 143 to the RAN 130; and a third UE 156 may wirelessly receive downlink communication 146 from the RAN 130 and wirelessly send uplink communication 145 to the RAN 130. For example but not limited to, a downlink communication may include a physical downlink shared channel (PDSCH) or a physical downlink control channel (PDCCH), and an uplink communication may include a physical uplink shared channel (PUSCH) or a physical uplink control channel (PUCCH).

In some implementations, the core network (CN) may include one or more core network functions related to the QoS information, as shown in FIG. 1B, which are described below. The core network may communicate with a UE 171, communicate with a RAN 172, and/or communicate with the UE via the RAN.

Further description of the functionality of the various network nodes and network functions related to the QoS information in the wireless communication network of FIG. 1B are described in more detail.

Referring to UPF (User plane function) 173, the UPF performs the functionalities including but not limited to serving as an anchor point for intra-/inter-radio access technology (RAT) mobility, packet routing and forwarding, traffic usage reporting, quality of service (QoS) handling for the user plane, downlink packet buffering and downlink data notification triggering. A UPF service area includes an area consisting of one or more tracking areas within which a communication session associated with the UPF can be served by RAN nodes via a direct interface (e.g., N3 interface as shown in FIG. 1B) between the RAN and the UPF without need to add a new UPF in between or to remove/re-allocate the UPF. The intermediate UPF (I-UPF) may be inserted/relocated when the UE moves outside of the UPF service area. An I-UPF may use, e.g., N3 tunnel as indicated in FIG. 1B, to connect with RAN 172 and may use, e.g., N9 tunnel as indicated in FIG. 1B.

Referring to AMF (Access and Mobility Management function) 176, the AMF performs the functionalities including but not limited to registration management, connection management of, reachability management and mobility management of UE 171. AMF also performs access authentication and access authorization. The AMF 176 may have function as non-access stratum (NAS) security termination and relay the session management NAS messages between the UE 171 and SMF 177. The AMF 176 also performs SMF selection function during communication session establishment procedure and UE mobility procedure. The AMF may forward the QoS profile from the SMF to the RAN (or AN), and forwards the QoS rule from the SMF to the UE.

Referring to SMF (Session Management Function) 177, the SMF performs the functionalities including but not limited to establishment, modification, and release of communication sessions, UE IP address allocation and management (including optional authorization functions), selection and control of UPF 173, and downlink data notification. Each SMF may control one or more UPFs and is associated with a service area being a collection of UPF service areas of all UPFs under its control. The SMF derives the QoS profile according to the PCC rule, generates a QoS flow, sends the QoS profile to the RAN, and sends the packet detection rule (PDR) to the UPF. The PCC rule is bound to the QoS flow. In some implementations, the SMF also selects the UPF based on the granularity of the UE or session, and can assign IP addresses, collect charging data, connect to the charging center, and so on. An I-SMF (Intermediate SMF) is inserted, changed or removed to a communication session as needed to control I-UPF (Intermediate UPF) which cannot be controlled by the original SMF 177 selected for the communication session because the they belong to a different SMF service area.

Referring to PCF (Policy Control Function) 184, the PCF is responsible for a unified policy framework, provides policy rules for control plane functions, determines policy control and charging (PCC) rules, and authorizes a session management function (SMF) on service data flow (SDF) basis. The PCF performs the functionalities including but not limited providing policy rules and controlling other network nodes to enforce the policy rules. Specifically the PCF provides access and mobility related policies to the AMF 176 so that the AMF 176 enforces them during mobility procedure.

Referring to UDR (Unified Data Repository) 181, the UDR may support the storage/retrieval of structured data for network exposure, application data (e.g., packet flow descriptions (PFDs) for application detection, application request information for multiple UEs, and application request for data traffic routing influence, as described above and in more detail below), and storage/retrieval of network group ID corresponding to subscriber identifier (e.g., External Group ID or Internal Group ID). A UDR may be located in the same public land mobile network (PLMN) as network application service to which it provides application data storage. The 5G System architecture allows the UDM, PCF and NEF to store data in the UDR, including subscription data and policy data by UDM and PCF, structured data for exposure and application data (including Packet Flow Descriptions (PFDs) for application detection, AF request information for multiple UEs) by the NEF.

Referring to UDM (unified data management) 185, the UDM is responsible for user identification, access authorization, and unified processing of user subscription data and authentication data.

Referring to NEF (Network Exposure Function) 182, these network nodes may store/retrieve information as structured data using a standardized interface (e.g., Nudr interface) to UDR. The NEF nay provide a means for the AFs to securely provide various information to the core network, including but not limited to information with respect to application influence on data traffic routing. The NEF may authenticate, authorize and assist in throttling requests from the application function (AF). Access to the NEF may be through open application programming interface (API) provided by the core network. A specific NEF instance may support one or more of these functionalities and consequently an individual NEF may support a subset of the APIs specified for NEFs. A NEF may be configured to access UDRs located in the same PLMN as the NEF.

Referring to AF (Application Function) 186, these network nodes may interact with the core network in order to provide services to applications. An AF may interact with the application on one end and the network functions in the core network via NEF on the other end. In some implementations, an AF considered as trusted by the core network may bypass the NEF and interact directly with other relevant network functions in the core network .AF interacts as the control plane of the application and transmits the QoS requirements/parameters of the application.

Referring to AUSF (authentication server function) 175, the AUSF may be responsible for authentication and access authentication, and may authenticate external applications and toB.

Referring to network function repository function (NRF) 183, the NRF may be responsible for the discovery and registration of network function services.

Referring to data network (DN) 174, the DN may corresponds to operator services, internet access or third-party services, etc. In some implementations, application (App) can be deployed in the DN.

In the core network, AMF, SMF, PCF, AUSF, UDR, UDM, NRF, NEF and AF may belong to the control plane; and UPF may belong to the user plane.

In 5G NR, the QoS information transmission is via the control plane. Before an application transmits service data, it may need to perform service authentication and user service subscription query via a NRF, a UDM, a UDR, an AUSF, etc. Then the PCF determines QoS policy such as PCC rules according to the obtained service requirements and subscription information, and the PCC rules include QoS parameters and charging policies. For the third-party applications, AF also needs to perform security authentication, service requirements and QoS information transmission via a NEF. The SMF performs the binding of SDFs to QoS Flows based on the QoS and service requirements. After receiving the PCC rules provided by the PCF, the SMF assigns the QFI for a new QoS flow and derives its QoS profile, corresponding UPF instructions and QoS rule(s) from the PCC rules and other information provided by the PCF. When a PDU session is established, the SMF transmits QoS information by configuring PDR for UPF, QoS profile for RAN, and QoS rule for UE. According to the QoS information from the SMF, the UPF maps the IP data flow into multiple QoS flows by means of a PDU session. The SMF provides the QoS profile to the access network via the AMF, thereby instructing the access network (AN) to perform data flow matching and mapping of radio bearers. The uplink transmission of the UE matches and maps the data packets according to the QoS rules, and the QoS rules are also sent to the UE by the SMF via the AMF in the NAS message. For the QoS flow of GBR, alternative QoS profiles can also be transmitted by enabling notification control, and the access network can select a set of appropriate QoS parameters from multiple sets of QoS profiles. The QoS profile may be used for long time in the PDU session until the RAN selects the alternative QoS profile and feedbacks it to CN. The QoS information transmission via the control plane is in semi-static mode.

In 5G NR, a QoS flow is associated with QoS requirements as specified by one or more QoS parameters and QoS characteristics in QoS information. Any QoS flow may be characterized by: a QoS profile provided by the SMF to the AN via the AMF over the N2 reference point or preconfigured in the AN; one or more QoS rule(s) and optionally QoS flow level QoS parameters associated with these QoS rule(s) which can be provided by the SMF to the UE via the AMF over the N1 reference point and/or derived by the UE by applying Reflective QoS control; and/or one or more UL and DL PDR(s) provided by the SMF to the UPF. For each QoS flow, the QoS profile may include the QoS parameters, for example, 5G QoS identifier (5QI), and/or allocation and retention priority (ARP). For each non-GBR QoS flow only, the QoS profile may also include the QoS parameter, for example, reflective QoS attribute (RQA). For each GBR QoS flow only, the QoS profile may also include the QoS parameters, for example, guaranteed flow bit rate (GFBR), and/or maximum flow bit rate (MFBR); In the case of a GBR QoS flow only, the QoS profile may also include one or more of the QoS parameters, for example, notification control, maximum packet loss rate. In 5G NR, the 5G QoS characteristics as the part of QoS profile associated with 5QI may include at least one of the following: resource type (e.g., GBR, delay critical GBR, or non-GBR), priority level, packet delay budget (including core network packet delay budget), packet error rate, averaging window (for GBR and/or delay-critical GBR resource type only), and/or maximum data burst volume (for delay-critical GBR resource type only). Standardized 5QI (e.g., non-dynamic 5QI) may indicate the standardized QoS characteristics to reduce signaling overhead. In the case of dynamic 5QI, the 5G QoS characteristics need to be in the QoS profile, which may be a large number of QoS parameters to cause the overhead of control plane.

In 5G NR, the QoS profile may be sent to the RAN by the SMF via the AMF over the N2 interface; the QoS rule may be sent by the SMF to the UE via the AMF over the N1 interface. The PDR may be regarded as a service data flow (SDF) template, which is provided by the SMF to the UPF. A reflective QoS attribute (RQA) is an optional QoS parameter which indicates that certain traffic carried on this QoS Flow is subject to Reflective QoS. Only when the RQA is signalled for a QoS Flow, the (R) AN enables the transfer of the Reflective QoS Indication (RQI) for AN resource corresponding to this QoS Flow. The RQA may be signalled to NG-RAN via the N2 reference point at UE context establishment in NG-RAN and at QoS Flow establishment or modification. In order to complete the above mapping process, multiple control plane processes are required, involving multiple control plane NFs of the core network and the QoS information is transmitted in signalling.

Above all, the transmission mechanism of QoS information via a control plane may be semi-static, a long chain and the means of a single. Traditional approaches for QoS information transmission may be delayed in time with poor accuracy and reliability.

The present invention provides a method and a device for transmitting QoS information on a user plane, addressing at least one of the problems/issues discussed above, reducing the signalling processing of the control plane, and/or improving the capability of transmitting the QoS information.

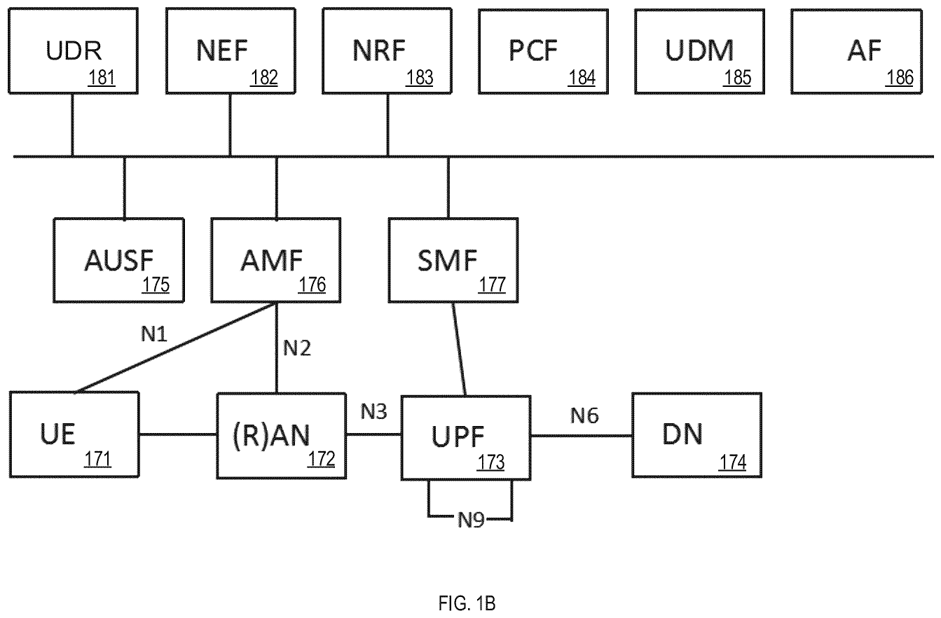

FIG. 2 shows an example of electronic device 200 to implement one or more core network functions or one or more base stations. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

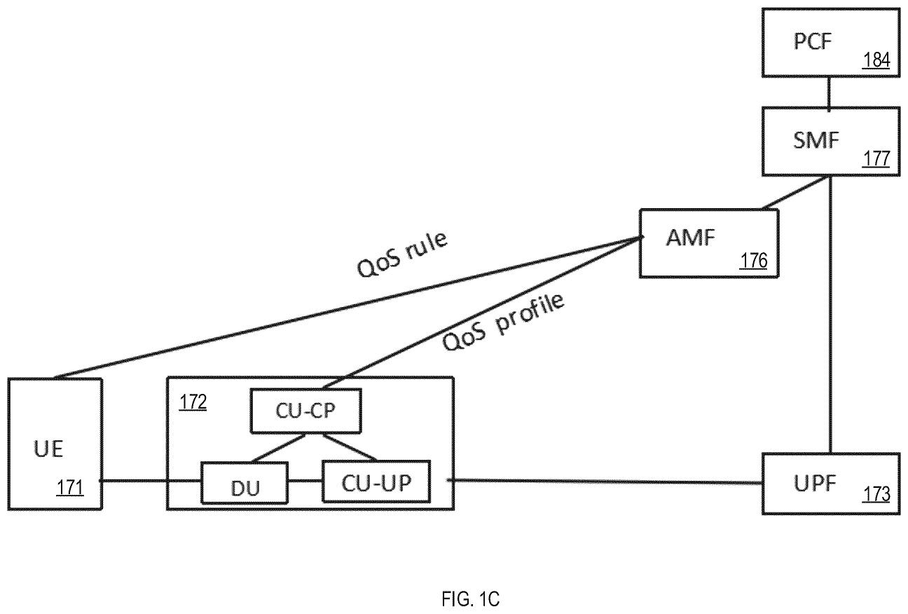

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for transmitting quality of service (QoS) information via a user plane, which may be implemented, partly or totally, on the core network function, the access network, and/or the user equipment described above in FIGS. 2-3. The various embodiments in the present disclosure may enable the transmission of QoS information via a user plane, which may deliver more QoS information, and/or deliver dynamic real-time QoS information. Moreover, the user plane transmission mechanism is different from the control plane transmission mechanism, which improve the reliability of QoS information transmission.

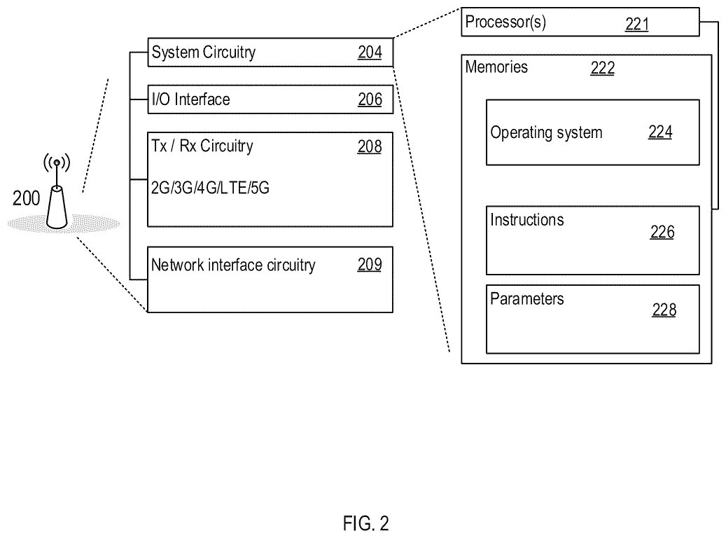

Referring to FIG. 4A, the present disclosure describes various embodiments of a method 400 for wireless communication. The method may include step 410: transmitting, by a first network element, first quality of service (QoS) information to a second network element by: transmitting, by the first network element, a data packet via user plane to the second network element, wherein the data packet comprises the first QoS information.

Referring to FIG. 4B, the present disclosure describes various embodiments of a method 450 for wireless communication. The method may include step 460: receiving, from a first network element by a second network element, first quality of service (QoS) information by: receiving, by the second network element, a data packet via user plane from the first network element, wherein the data packet comprises the first QoS information.

In some implementations, the first network element comprises one of a core network (CN), a user plane function (UPF), a radio access network (RAN), a serve data adaptation protocol (SDAP) layer, a packet data convergence protocol (PDCP) layer, a radio link control (RLC) layer, a medium access control (MAC) layer, a centralized unit (CU), a distributed unit (DU), an application server, an edge node, a base station, a backhaul adaptation protocol (BAP) layer, an integrated access backhaul (IAB) node, or a user equipment (UE). The edge node may be mobile edge computing(MEC) node or multi-access edge computing(MEC) node.

In some implementations, the second network element comprises one of a core network (CN), a UPF, a radio access network (RAN), a serve data adaptation protocol (SDAP) layer, a packet data convergence protocol (PDCP) layer, a radio link control (RLC) layer, a medium access control (MAC) layer, a centralized unit (CU), a distributed unit (DU), an application client, an edge node, a base station (BS), a backhaul adaptation protocol (BAP) layer, an IAB node, or a user equipment (UE). The edge node may be mobile edge computing (MEC) node or multi-access edge computing (MEC) node.

In some implementations, the first QoS information comprises at least one of the following: one or more packet detection rules (PDRs), one or more policy control and charging (PCC) rules, one or more QoS profiles, one or more QoS rules, one or more QoS parameters, one or more QoS characteristics, one or more alternative QoS profiles, one or more alternative QoS sets, one or more QoS identifiers (IDs), one or more QoS information indexes, one or more QoS parameter ranges, one or more 5G QoS Identifiers (5QIs), one or more QoS profile indexed, one or more QoS parameter set indexed, one or more QoS parameter set index ranges, one or more QoS types, or one or more QoS groups.

In some implementations, the user plane comprises at least one of the following: a user plane function (UPF), a user plane of a serve data adaptation protocol (SDAP) layer, a user plane of a packet data convergence protocol (PDCP) layer, a user plane of a radio link control (RLC) layer, a user plane of a medium access control (MAC) layer, a user plane of a centralized unit-distributed unit (CU-DU) interface (F1-U), a CU-user plane (CU-UP), a DU-UP, a general packet radio service tunneling protocol user plane (GTP-U), a next generation user plane (NG-U), an Xn user plane (Xn-U), a user plane of QoS flow, a user plane of a CN-RAN interface, a user plane of an inter-BS interface, a X2-U, a user plane of a backhaul adaptation protocol (BAP) layer, or a user plane of an integrated access backhaul (IAB) node.

In some implementations, the data packet comprising the first QoS information comprises: the first QoS information is located in a header of the data packet; or the first QoS information is located in a pre-defined data region of the data packet. In some implementations, the first QoS information is transmitted, along with other data, in the pre-defined data region of the data packet, or the first QoS information is transmitted, alone, in the pre-defined data region of the data packet. In some implementations, the data region may be referred to data field. In some implementations, the data region may be referred to data domain.

In some implementations, the data packet comprising the first QoS information comprises: the first QoS information is located in one of the following: a PDU header, a control PDU, a data PDU, or a MAC control element (CE), a PDU header field, a PDU data field.

In some implementations, the method 400 or the method 450 may further include transmitting, by the first network element, second QoS information via control plane to the second network element.

In some implementations, content of the first QoS information and content of the second QoS information are different or same.

In some implementations, when the content of the first QoS information and the content of the second QoS information are different, one of the following may be performed: the first QoS information is mapped to a DRB, and the second QoS information is mapped to a signaling radio bearer (SRB); the first QoS information is transmitted via the user plane, and the second QoS information is transmitted via the control plane; the first QoS information is transmitted via a data flow, and the second QoS information is transmitted via a message; the first QoS information is transmitted via the data packet, and the second QoS information is transmitted via a signaling; or the first QoS information is transmitted via the data packet, and the second QoS information is transmitted via an information element (IE).

In some implementations, when the content of the first QoS information and the content of the second QoS information are same, one of the following may be performed: the first QoS information is mapped to a DRB, and the second QoS information is mapped to a signaling radio bearer (SRB); the first QoS information is transmitted via the user plane, and the second QoS information is transmitted via the control plane; the first QoS information is transmitted via a data flow, and the second QoS information is transmitted via a message; the first QoS information is transmitted via the data packet, and the second QoS information is transmitted via a signaling; or the first QoS information is transmitted via the data packet, and the second QoS information is transmitted via an information element (IE).

In some implementations, the step of transmitting the first QoS information to the second network element may include at least one of the following: transmitting the first QoS information in each packet to the second network element; transmitting the first QoS information in a first packet to the second network element; transmitting the first QoS information as an independent data packet to the second network element; transmitting the first QoS information in a packet in a periodical manner to the second network element; transmitting the first QoS information in a packet in a non-periodical manner to the second network element; transmitting the first QoS information in a total-sub QoS manner to the second network element; transmitting the first QoS information in differential QoS manner to the second network element; transmitting the first QoS information in a primary-secondary QoS manner to the second network element; or transmitting the first QoS information in one or more QoS-list manner to the second network element.

In some implementations, the step of transmitting the first QoS information to the second network element may include a portion or all of the following: mapping, by the first network element, the first QoS information as data of a data flow; and/or transmitting, the first QoS information as the data flow to the second network element.

In some implementations, the data flow is a shared data flow for the QoS information data and the service data; or the data flow is a dedicated data flow for the QoS information.

In some implementations, the first QoS information corresponds to an entity, wherein the entity comprises at least one of the following: a serve data adaptation protocol (SDAP) entity, a packet data convergence protocol (PDCP) entity, a radio link control (RLC) entity, a medium access control (MAC) entity, QoS related entity, a backhaul adaptation protocol (BAP) entity, or an integrated access backhaul (IAB) entity.

In some implementations, a mapping method of the first QoS information comprises at least one of the following: mapping the first QoS information to a shared data radio bearer (DRB) with service data; mapping the first QoS information to a dedicated DRB without service data; mapping the first QoS information to a dedicated QoS radio bearer; mapping the first QoS information to a shared logic channel with service data; mapping the first QoS information to a dedicated logic channel without service data; mapping the first QoS information to a shared logic channel group with service data; mapping the first QoS information to a dedicated logic channel group without service data; mapping the first QoS information to a shared data channel with service data; or mapping the first QoS information to a dedicated data channel without service data.

In some implementations, the first QoS information is mapped to a data channel, and is transmitted to the second network element via the data channel.

In some implementations, the method 400 and/or the method 450 may further include performing, by the first network element, a re-transmission of the data packet comprising the first QoS information via the user plane to the second network element, wherein the re-transmission comprises one of the following: automatic repeat request (ARQ) re-transmission mechanism, or hybrid automatic repeat request (HARQ) re-transmission mechanism.

In some implementations, the first QoS information is transmitted via the user plane at a granularity level to the second network element, wherein the granularity level comprises at least one of the following: on per-flow basis, on per-PDU basis, on per-PDU set basis, on per-frame basis, on per-packet basis, or on per-slot basis.

In some implementations, the first QoS information comprises at least one of the following: total QoS information, sub QoS information, hierarchic QoS information, QoS information with different priority, or QoS information in a tree structure.

In some implementations, the first QoS information is generated by a third network element, and/or the first network element is connected to the third network element to obtain the first QoS information.

In some implementations, the third network element comprises one of a QoS information generation element, an application server, a PCF, a QoS controller, a CN, a RAN, or a UE.

The present disclosure describes below a plurality of various non-limiting embodiments and/or examples for transmitting quality of service (QoS) information via a user plane. These embodiments and/or samples are described as some of many possible implementations of the present disclosure, and do not impose any limitations on the present disclosure.

### Embodiment 1

The present disclosure describes an embodiment for transmitting quality of service (QoS) information via user plane, wherein a core network determines QoS information and transmits the QoS information to an access network via user plane. The advantage is that when a large number of QoS parameters are transmitted, the control plane process and signaling overhead may be reduced, and a lightweight control plane may be realized. In some implementations, the network (e.g., the core network and/or the access network) may directly face to custom-level and application-level QoS information.

In some implementations, multiple QoS parameters may be passed to the user plane of the access network from a UPF or may be passed to other UPFs. In 5G NR, the transmission of QoS information requires a SMF to provide the QoS profile to the access network through an AMF, and the SMF needs to send the QoS profile to the UE via the AMF with NAS messages. In some implementations, in order to better match the needs of the access network, an alternative QoS mechanism may be introduced in 5G NR. When the PCF enables a notification control, the core network transmits multiple sets of QoS profiles via the control plane. When the access network finds that the QoS requirements cannot be guaranteed/satisfied, it selects a set of appropriate QoS parameters from multiple sets of QoS profiles for alternative QoS. In order not to increase too much overhead to the control plane, the alternative QoS method may only transmit a limited number of indexes of the QoS profile, and may not transmit a large amount of QoS information for specific QoS parameters. The way of transmission of QoS information on the user plane may flexibly expand the index range of the QoS profile and transmit more specific QoS parameters. Transmitting QoS information on the user plane may also simplify the control plane process, reduce the signaling transmission on the control plane, and/or reduce the processing burden on the control plane and deliver more real-time and dynamic QoS information.

For one non-limiting example of transmission of QoS information on the user plane, the core network determines the QoS information such as the QoS profile, the QoS profile index range, the specific QoS parameters, the specific QoS characteristics, the QoS rule by the PCF, and PCF sends them to the SMF. The SMF transmits them into the UPF, and the UPF transmits them to the access network. In some implementations, the UPF may use, for example, a communication interface (e.g., a N3 interface) to transmit QoS information as QoS flow data to the access network. In some other implementations, different systems may use different interfaces other than the N3 interface. For example, a 6G system may use an interface other than N3 interface, for example, a service-based architecture (SBA) interface to perform the above and some other operations. Different from the way of PCF->SMF->AMF->RAN, transmission of QoS information on the user plane is in the way of PCF->SMF->UPF->RAN. Moreover, the amount of QoS information on the user plane may be larger than on the control plane.

For another non-limiting example, due to a high-speed movement of a UE or a high-speed movement of a base station (BS), service data may need to be migrated from one UPF to another UPF. In some implementations, one or more UPF may be deployed locally, and one or more AMF, SMF, and PCF may be deployed at a larger scale (e.g., at a national or provincial level). Moreover, upon the UE and/or the base station moving across regions, when the original SMF cannot provide services for the UE, an intermediate SMF (I-SMF) may be used to assist the SMF to control the forwarding. For high mobility scenarios, the QoS transmission chain of 5G NR may be long and may not meet the high-speed mobility requirements. With various embodiments and/or examples described in the present disclosure for transmitting QoS on the user plane, the QoS information may be directly forwarded from one UPF to another UPF via a communication interface (e.g., an N9 interface), without the process of control NF such as PCF, SMF, AMF, which may shorten the time of QoS transmission, enhance the service continuity, and/or enhance user/service experience.

In some implementations, during the moving process, QoS information migration may be performed with UPF switching. When a certain condition is met or a certain message is received, the UPF may be triggered to transmit QoS information to another UPF. For example, when I-UPF is inserted by the SMF, QoS information is transmitted from the old UPF to the new I-UPF.

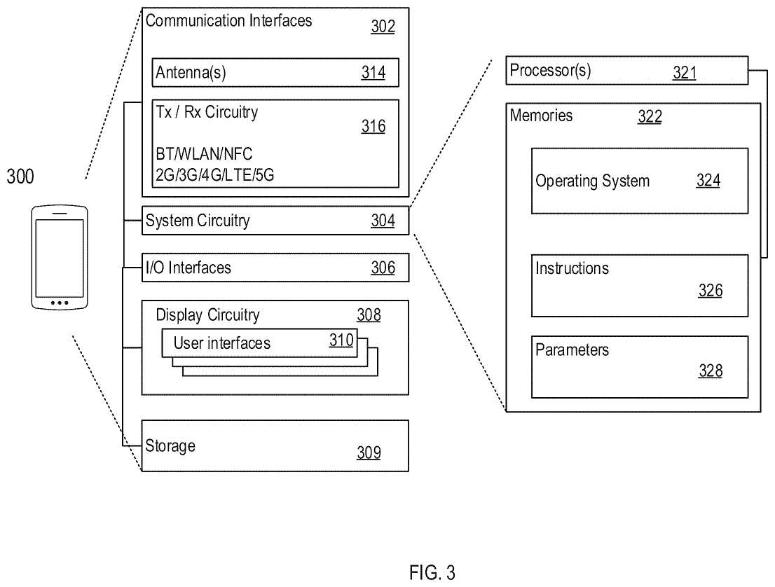

FIG. 5 shows a schematic diagram of a user plane QoS information transfer in mobile scenario, which may include a portion or all of the following: an AMF 501, a SMF 512, an I-SMF 514, a UPF1 522, a UPF2 524, and/or a UPF3 526. The I-SMF may be used to control the UPF3. In some implementations, the QoS information may be directly forwarded from the UPF2 to the UPF3 through a communication interface (e.g., N9 interface).

In some implementations, a new QoS node/element (e.g., QoS network function) may be used to directly connect to the RAN. The new QoS node/element provides the QoS information to RAN and/or UE for QoS information transmission on the user plane. The new QoS node/element may generate the QoS information and/or manage the QoS information.

For another non-limiting example, in a to-business (toB) scenario, the users are with group characteristics, and thus, network elements of the control plane may be further simplified. For example, in industrial area or automated factories, there is non-charging policies, low mobility and high customization. Therefore, in the toB scenario, the application server may directly customize the QoS information and pass them to the access network on a user plane (e.g., from a UPF to the RAN or directly from the application server to RAN user plane). In some implementations, the QoS information is transmitted in data flow. In some implementations, intent-driven applications generate the QoS information for QoS customization. In some other implementations, the control plane may be a lightweight implementation, so that the light control plane only performs basic and simple processing such as session establishment, and may not perform transmission of QoS information. In some implementations, the QoS information on the control plane transmits is small amount and the QoS information on the user plane transmits is large amount. In some implementations, the QoS information on the control plane transmission is non-real time and the QoS information on the user plane transmission is real time. In some implementations, the QoS information on the control plane transmission is semi-static and the QoS information on the user plane transmission is dynamic. In some implementations, the QoS information on the control plane transmission is simple and rough and the QoS information on the user plane transmission is detailed and explicit.

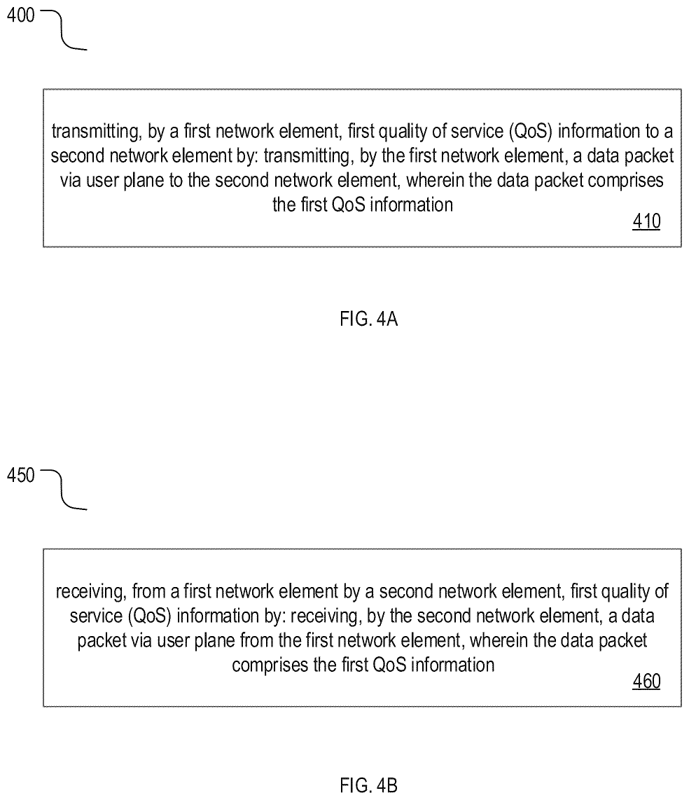

FIG. 6 shows a schematic diagram of a customized QoS transmitted through the user plane, which may include a portion or all of the following: a UE 601, a RAN 603, a UPF 605, and/or an application server 607. The application server may directly customize the QoS parameters, QoS requirement, and/or other QoS information; and the application server may pass them to the access network on a user plane (e.g., from a UPF to a SDAP layer).

### Embodiment 2

The present disclosure describes another embodiment for transmitting quality of service (QoS) information via a user plane, wherein a user plane may transmit QoS information in a data packet, for example but not limited to, putting into a PDU header, a control PDU, a data PDU, and/or a MAC CE. According to dynamic QoS information in the data packet, the access network may flexibly map the data flows to the bearers. The embodiment addresses at least one of the problems/issues associated with transmitting QoS information, achieving the advantages and improvement in the technical field of telecommunication, for example, real-time and dynamic resource adjustment may be performed according to data packet requirements, and/or more fine-grained QoS granularity such as on per-packet basis may be achieved.

For one non-limiting example, QoS information may comprise one or more specific QoS parameters, for example but not limited to, 5QI, ARP, RQA, GFBR, MFBR, notification control, maximum packet loss rate, resource type, priority level, packet delay budget, packet error rate, averaging window, maximum data burst volume, etc. In some implementations, the QoS information may also comprise one or more specific QoS index value, such as 5QI, QoS profile index, QoS parameters set index, QoS parameters set index range, and the like.

In some implementations, the QoS information in the data packet is transmitted on the user plane, so the dynamic control of data packets can be realized. For example, there are 20 packets from a UPF to a SDAP layer. The first packet carries the QoS0 and the eleventh packet carries the QoS1. QoS0 is the QoS information for the packets from the first packet to the tenth packet and QoS1 is the QoS information for the packets from the eleventh packet to the twentieth packet. According to the QoS0 and QoS1, the SDAP layer maps the previous ten packets to one DRB and the subsequent ten packets to another DRB.

In some implementations, the QoS information may be transmitted in one or more of the following ways: QoS information is transmitted in each packet, QoS information is transmitted in packets based on periodicity, and/or QoS information is transmitted in packets based on aperiodicity. For QoS information in each packet, each packet has its QoS control. For example, a application frame is corresponding to a packet, each application frame has its own QoS requirement such as different importance. RAN detects the QoS information of the packet and allocates resources according to the QoS information of the packet. The packet with high priority may be allocated in better resources. The resource may be radio bearer (RB), logic channel (LC), logic channel group (LCG), time resource, frequency resource or power resource. For the periodic mode, QoS information may be transmitted by every m packet or every n time interval, wherein m and n is the number. In internet of things (IoT) scenario, it is beneficial to transmit the important QoS information periodically to successful reception of important QoS information. For the aperiodic mode, dynamic QoS control may be performed by real-time insertion of QoS information. For example, the first packet carries QoS information and this QoS information is used for QoS control of the following packets, until the packer carrying new QoS information appears.

In some implementations, in the core network, the core network directly maps and transmits QoS information as service data to realize the transmission of QoS information on the user plane. For example but not limited to, mapping QoS information and service data to a same data flow (e.g. QoS flow), which means QoS information is mapped to one data flow (e.g. QoS flow1) with service data together. For example but not limited to, mapping QoS information and service data to different data flows (e.g. QoS flows), which means QoS information is individually mapped to a data flow (e.g. QoS flow1 or QoS information dedicated flow) and service data is mapped to another data flow (e.g. QoS flow2).

In some implementations, QoS information may be transmitted in the packet header, extension header or data area of general packet radio service (GPRS) tunneling protocol user plane (GTP-U), such as GTP-U PDU header, GTP-U PDU domain, GTP extension header. For example, GTP extension header may be GTP version1 user plane (GTPv1-U) extension header. The interfaces for transmitting QoS information on the user plane may include but are not limited to: the user plane interface from the core network user plane UPF to the RAN, the user plane interface Xn-U between 5G NR base stations, the user plane interface X2-U between the 4G base stations, and/or the CU-DU User plane interface F1-U.

In some implementations, the transmission of QoS information may be mapped on the user plane of each layer such as SDAP, PDCP, RLC, and MAC of the access network. Specifically, QoS information may be mapped to PDU data header, PDU data domain, control element (CE), control PDU, data PDU, etc. In some implementations, QoS information may be carried in the data packet header, such as SDAP PDU header, PDCP PDU Data header, RLC PDU header, MAC PDU header. In some implementations, QoS information may be carried in the data PDU such as SDAP PDU, PDCP PDU Data, RLC PDU, MAC PDU and so on. In some implementations, QoS information may be carried in the control PDU, such as RLC control PDU, PDCP control PDU. In some implementations, QoS information may be mapped in PDU header field, PDU data field, control element (CE) field, etc.

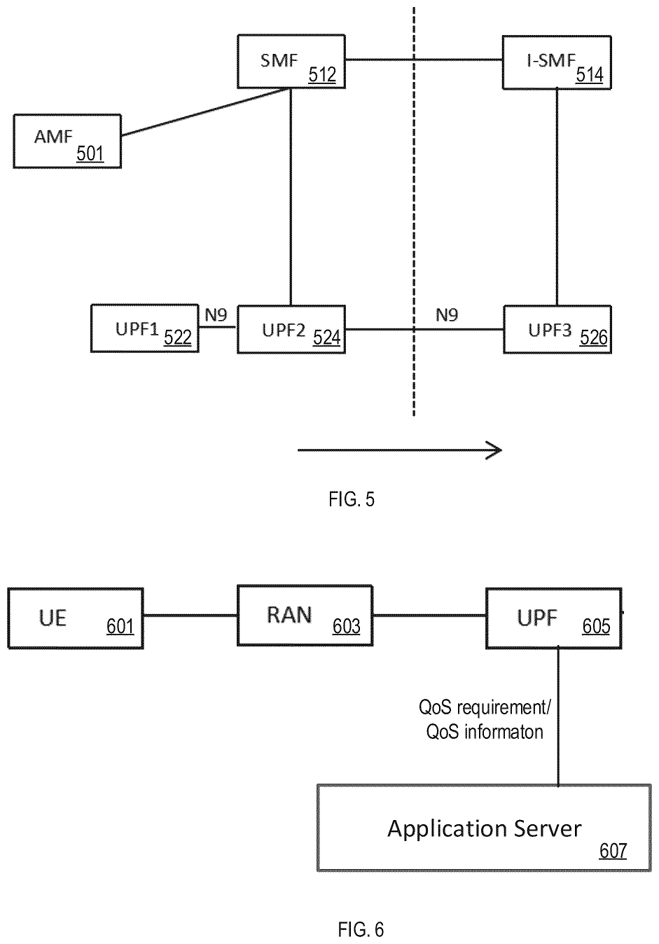

FIG. 7 shows an exemplary schematic diagram of including QoS information into SDAP PDU data field for transmission. A SDAP PDU header may include at least one of the following of indications: QoS flow indication (QFI), reflective QoS flow to DRB mapping indication (RDI), reflective QoS indication (RQI). In this case, the QoS information does not comprise QFI, RDI, and/or RQI. The QoS information is regarded as service data (may be called as QoS parameter information data) and is mapped to data domain. In some implementations, the data domain may be data field.

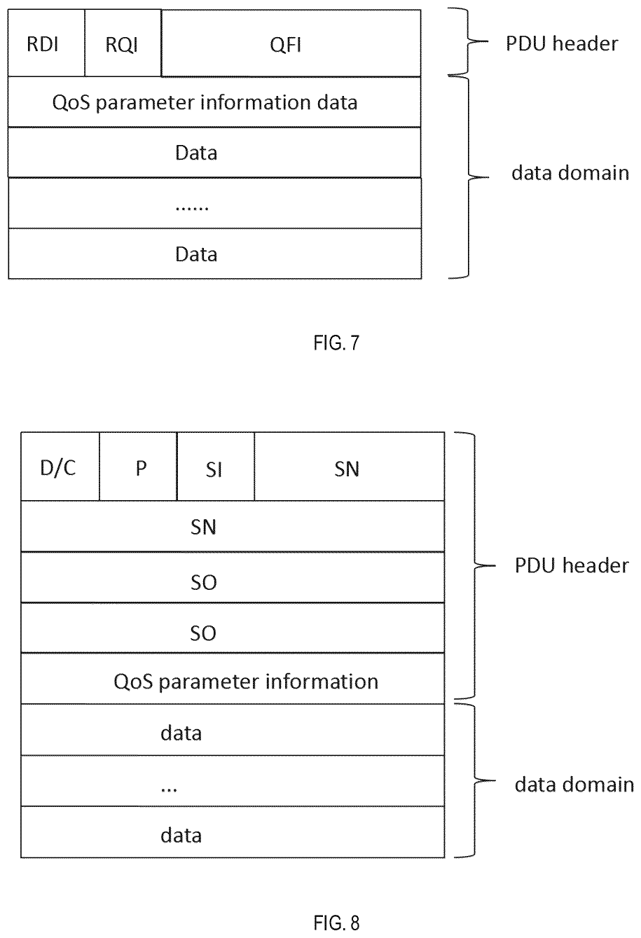

FIG. 8 shows another exemplary schematic diagram showing that QoS information is included in the RLC PDU header for transmission. In 5G NR, a RLC PDU header may include at least one of the following: data/control (D/C) field, polling bit (P) field, sequence number (SN) field, segmentation info (SI) field, segment offset (SO), and/or segment offset (SO) field. The new field of QoS information (may be called as QoS parameter information) is added in the RLC PDU header.

In some implementations, QoS information may be carried in the packet transmission, indicating quality requirements of the associated traffic. For example, the QoS information may be transmitted in the first packet, indicating the QoS requirement, QoS parameter profile, and/or QoS policy of the subsequent consecutive data packets. When the QoS information is needed to update, the new packet may carry the new QoS information to indicate the subsequent packets. This implementation may avoid the repeated sending of same QoS information, may reduce the requirements for the control plane, and/or may reduce the transmission burden on the user plane. In some implementations, the differential QoS information may be transmitted in the packet transmission. For example, the basic QoS information may be transmitted in the first packet, and the differential QoS information may be transmitted in the second packet. The whole QoS information of the second packet is obtained by aggregation of basic QoS information and the differential QoS information.

In some implementations, the QoS information is transmitted as an independent data packet, and this special packet is called QoS packet. The QoS packet only comprises the QoS information. In some implementations, QoS packet has special QoS packet header. By analyzing and detecting QoS packets, it can help to improve network efficiency according to the QoS information.

In some implementations, the transmission of QoS in the user plane may be transmitted in a structured manner. In some implementations, specific structuring methods include, but are not limited to, the total-sub structure, primary-secondary structure, super class and subclass structure, and/or tree structure. The QoS information with the total-sub structure may include the whole of QoS information description, and the part of the specific QoS parameters and/or the specific QoS policy. The QoS information with the primary-secondary structure may include high-level QoS information, low-level QoS information, and the like. The QoS information with the primary-secondary structure may include super class QoS information and subclass QoS information, and the like. The QoS information with the primary-secondary structure may include multiple level QoS information. The QoS information with one or more QoS-list structure may include a portion or all of the following: QoS parameter set, QoS policy set, QoS feature set, QoS requirement set and so on. The QoS information with one or more QoS-list structure may be tree structure.

In some implementations, the QoS information may correspond to an entity, such as SDAP entity, PDCP entity, RLC entity, MAC entity, and/or QoS related entity.

In some implementations, the QoS information mapping method may include but is not limited to at least one of the following: mapping with service data to one DRB; mapping to one DRB without service data; mapping with service data to one logical channel; mapping to one logical channel without service data; mapped to one data channel with service data; and/or mapped to one data channel without service data. In some implementations, the QoS information may be mapped to a dedicated data flow. In some implementations, the QoS information may be mapped to a dedicated radio bearer. In some implementations, the QoS information may be mapped to a dedicated physical channel. In some implementations, the QoS information may be mapped to a dedicated logical channel. In some implementations, the QoS information may be mapped to a dedicated logical channel group (LCG).

In some implementations, the QoS information mapping method may perform dynamic mapping of radio bearers, including but not limited to at least one of the following: a part of the QoS information can be mapped to the SRB, and/or another part of the QoS information can be mapped to the DRB.

In some implementations, the QoS information may be mapped to the data transmission channel (DCH), and/or may be sent to the UE in the data channel.

In 5G NR, QoS rules are sent to the access network in NAS messages, and the access network encapsulates the QoS rules into RRC signaling and maps them to the signaling bearer (SRB). The retransmission mechanism is not appropriate for SRB. In some implementations, the QoS information via the user plane may be reliably transmitted using a repeated transmission (re-transmission) mechanism such as ARQ and HARQ. In some implementations, the QoS information such as QoS rule sent to the UE is transmitted the user plane of the access network (AN) as user service data, and the QoS information is mapped to the data radio bearer (DRB). In some implementations, the QoS information may be transmitted via the user plane by using the user plane repeated transmission mechanism to improve the transmission success rate. For example, the ARQ mechanism is used for re-transmission at the RLC layer, and the HARQ mechanism may be used for re-transmission of the QoS information at the physical layer. For example, QoS information may be transmitted on the user plane of the access network and the QoS information may be transmitted for scheduling and resource allocation as transport block (TB). The TBs carried QoS information may be re-transmission by HARQ.

### Embodiment 3

The present disclosure describes another embodiment for transmitting quality of service (QoS) information via a user plane, wherein QoS information may be transmitted on the control plane and may be transmitted on the user plane at the same time to realize the effect of QoS system-level dual connection. The advantage/benefit with this embodiment may include that this approach may satisfy/meet the high availability or reliability requirements of the industry, and/or may provide reliability guarantee and redundant backup. QoS information via a user plane and QoS information via control are two different mechanisms. The two mechanisms provide the availability/reliability similar to dual connection in the system level.

In some implementations, toB has high availability requirements. For example, high availability/reliability is achieved through the diversity of different technologies and systems in aviation, wherein equipment and services from different companies, technologies and systems are specially used at the same time. In order to ensure the reliability of the toB service, the ToB may also have two sets of QoS mechanisms: (1) QoS information is transmitted and controlled on the control plane; and/or (2) QoS information is transmitted and controlled on the user plane. Using two sets of QoS mechanisms at the same time can provide system-level diversity gain and achieve system-level dual connectivity and high reliability. For example, the QoS information transmission of the control plane of manufacturer A is used, and the QoS information transmission of the user plane of manufacturer B is used at the same time. If there is a breakdown in the QoS transmission of manufacturer A, manufacturer B can provide supplementary QoS information.

In some implementations, two sets of QoS mechanisms may also be used to implement QoS transmission and control of different granularities. For example, the semi-static QoS information is transmitted via the control plane, and the dynamic real-time QoS information is transmitted via the user plane. In some implementations, the coarse-grained QoS information is transmitted via the control plane, and the QoS information refined based on the coarse-grained QoS information is transmitted via the user plane. In some implementations, the transmits QoS parameter sets with larger set index ranges is transmitted via the control plane, and the QoS parameter sets with smaller set index ranges is transmitted via the user plane.

In some implementations, the granularity of the QoS information transmitted in the user plane may be various, including but not limited to at least one of the following: flow based, PDU based, PDU set based, frame based, slot based and packet based. For example, for the XR service, service frames of different importance correspond to different PDU sets, and the QoS information based on the PDU set can accurately reflect the QoS requirements of different service frames.

The present disclosure describes methods, apparatus, and computer-readable medium for wireless communication. The present disclosure addressed the issues with configuring and/or transmitting QoS information via a user plane. The methods, devices, and computer-readable medium described in the present disclosure may facilitate the performance of wireless communication by configuring and/or transmitting QoS information via a user plane, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
transmitting, by a first network element, first quality of service (QoS) information to a second network element by:
transmitting, by the first network element, a data packet via user plane to the second network element, wherein the data packet comprises the first QoS information.

2. A method for wireless communication, comprising:
receiving, from a first network element by a second network element, first quality of service (QoS) information by:
receiving, by the second network element, a data packet via user plane from the first network element, wherein the data packet comprises the first QoS information.

3. (canceled)

4. (canceled)

5. The method according to claim 1, wherein:
the first QoS information comprises at least one of the following: one or more packet detection rules (PDRs), one or more policy control and charging (PCC) rules, one or more QoS profiles, one or more QoS rules, one or more QoS parameters, one or more QoS characteristics, one or more alternative QoS profiles, one or more alternative QoS sets, one or more QoS identifiers (IDs), one or more QoS information indexes, one or more QoS parameter ranges, one or more 5G QoS Identifiers(5QIs), one or more QoS profile indexes, one or more QoS parameter set indexes, one or more QoS parameter set index ranges, one or more QoS types, or one or more QoS groups.

6. (canceled)

7. The method according to claim 1, wherein the data packet comprising the first QoS information comprises:
the first QoS information is located in a header of the data packet; or
the first QoS information is located in a pre-defined data region of the data packet, wherein:
the first QoS information is transmitted, along with other data, in the pre-defined data region of the data packet, or
the first QoS information is transmitted, alone, in the pre-defined data region of the data packet.

8. The method according to claim 1, wherein the data packet comprising the first QoS information comprises:
the first QoS information is located in one of the following: a PDU header, a control PDU, a data PDU, a MAC control element (CE), a PDU header field, or a PDU data field.

9. The method according to claim 1, further comprising:
transmitting, by the first network element, second QoS information via control plane to the second network element.

10. (canceled)

11. The method according to claim 9, further comprising at least one of the following:
the first QoS information is mapped to a DRB, and the second QoS information is mapped to a signaling radio bearer (SRB);
the first QoS information is transmitted via the user plane, and the second QoS information is transmitted via the control plane;
the first QoS information is transmitted via a data flow, and the second QoS information is transmitted via a message;
the first QoS information is transmitted via the data packet, and the second QoS information is transmitted via a signaling; or
the first QoS information is transmitted via the data packet, and the second QoS information is transmitted via an information element (IE).

12. The method according to claim 1, wherein transmitting the first QoS information to the second network element comprises at least one of the following:
transmitting the first QoS information in each packet to the second network element;
transmitting the first QoS information in a first packet to the second network element;
transmitting the first QoS information as an independent data packet to the second network element;
transmitting the first QoS information in a packet in a periodical manner to the second network element;
transmitting the first QoS information in a packet in a non-periodical manner to the second network element;
transmitting the first QoS information in a total-sub QoS manner to the second network element;
transmitting the first QoS information in differential QoS manner to the second network element;
transmitting the first QoS information in a primary-secondary QoS manner to the second network element; or
transmitting the first QoS information in one or more QoS-list manner to the second network element.

13. The method according to claim 1, wherein transmitting the first QoS information to the second network element comprises:
mapping, by the first network element, the first QoS information as data of a data flow; and
transmitting, by the first network element, the first QoS information as the data flow to the second network element.

14. The method according to claim 13, wherein:
the data flow is a shared data flow for the QoS information and the service data; or
the data flow is a dedicated data flow for the QoS information.

15. The method according to claim 1, wherein:
the first QoS information corresponds to an entity, wherein the entity comprises at least one of the following: a serve data adaptation protocol (SDAP) entity, a packet data convergence protocol (PDCP) entity, a radio link control (RLC) entity, a medium access control (MAC) entity, a QoS related entity, a backhaul adaptation protocol (BAP) entity, or an integrated access backhaul (IAB) entity.

16. The method according to claim 1, wherein:
a mapping method of the first QoS information comprises at least one of the following:
mapping the first QoS information to a shared data radio bearer (DRB) with service data;
mapping the first QoS information to a dedicated DRB without service data;
mapping the first QoS information to a dedicated QoS radio bearer;
mapping the first QoS information to a shared logic channel (LC) with service data;
mapping the first QoS information to a dedicated logic channel (LC) without service data;
mapping the first QoS information to a shared logic channel group (LCG) with service data;
mapping the first QoS information to a dedicated logic channel group (LCG) without service data;
mapping the first QoS information to a shared data channel with service data; or
mapping the first QoS information to a dedicated data channel without service data.

17. The method according to claim 1, wherein:
the first QoS information is mapped to a data channel, and is transmitted to the second network element via the data channel.

18. The method according to claim 1, further comprising:
performing, by the first network element, a re-transmission of the data packet comprising the first QoS information via the user plane to the second network element, wherein the re-transmission comprises one of the following: an automatic repeat request (ARQ) re-transmission mechanism or a hybrid automatic repeat request (HARQ) re-transmission mechanism.

19. The method according to claim 1, wherein:
the first QoS information is transmitted via the user plane at a granularity level to the second network element, wherein the granularity level comprises at least one of the following: on per-flow basis, on per-PDU basis, on per-PDU set basis, on per-frame basis, on per-packet basis, on per-TB basis, on per-DRB basis, on per-LC basis, on per-LCG basis, on per-physical channel basis, or on per-slot basis.

20. The method according to claim 1, wherein:
the first QoS information comprises at least one of the following: total QoS information, sub QoS information, hierarchic QoS information, QoS information with different priority, or QoS information in a tree structure.

21-24. (canceled)

25. The method according to claim 2, wherein:
the first QoS information comprises at least one of the following: one or more packet detection rules (PDRs), one or more policy control and charging (PCC) rules, one or more QoS profiles, one or more QoS rules, one or more QoS parameters, one or more QoS characteristics, one or more alternative QoS profiles, one or more alternative QoS sets, one or more QoS identifiers (IDs), one or more QoS information indexes, one or more QoS parameter ranges, one or more 5G QoS Identifiers (5QIs), one or more QoS profile indexes, one or more QoS parameter set indexes, one or more QoS parameter set index ranges, one or more QoS types, or one or more QoS groups.

26. The method according to claim 2, wherein the data packet comprising the first QoS information comprises:
the first QoS information is located in a header of the data packet; or
the first QoS information is located in a pre-defined data region of the data packet, wherein:
the first QoS information is transmitted, along with other data, in the pre-defined data region of the data packet, or
the first QoS information is transmitted, alone, in the pre-defined data region of the data packet.

27. An apparatus comprising:
a memory storing instructions; and
at least one processor in communication with the memory, wherein, when the at least one processor executes the instructions, the at least one processor is configured to cause the apparatus to perform:
transmitting first quality of service (QoS) information to a network element by:
transmitting a data packet via user plane to the network element, wherein the data packet comprises the first QoS information.

28. An apparatus comprising:
a memory storing instructions; and
at least one processor in communication with the memory, wherein, when the at least one processor executes the instructions, the at least one processor is configured to cause the apparatus to perform:
receiving, from a network element, first quality of service (QoS) information by:
receiving a data packet via user plane from the network element, wherein the data packet comprises the first QoS information.
